(19) United States
(12) Patent Application Publication
(10) Pub. No.: US 2024/0213846 A1
(43) Pub. Date: Jun. 27, 2024

(54) INCREASE STIFFNESS OF ALUMINIUM DIE-CAST HOUSING BY CAST IN A REINFORCEMENT MADE OF STEEL

(71) Applicant: Valeo eAutomotive Germany GmbH, Erlangen (DE)

(72) Inventors: Alexander SCHLERETH, Bad Neustadt a.d.Saale (DE); Nico WOLF, Bad Neustadt a.d.Saale (DE); Thomas TROTT, Bad Neustadt a.d.Saale (DE); Nimal-Kumar MADAN-KUMAR, Erlangen (DE)

(73) Assignee: Valeo eAutomotive Germany GmbH, Erlangen (DE)

(21) Appl. No.: 18/558,044

(22) PCT Filed: Apr. 28, 2022
(86) PCT No.: PCT/EP2022/061378

§ 371 Date: Oct. 30, 2023

(30) Foreign Application Priority Data
Apr. 30, 2021 (DE) 10 2021 204 329.1

(51) Int. Cl. H02K 5/15; H02K 5/06; H02K 15/14

(52) U.S. Cl. CPC H02K 5/15; H02K 5/06; H02K 15/14

(57) ABSTRACT

A housing for an electric machine has a hollow-cylindrical housing casing and a circular bearing plate composed of a first material which is arranged at one axial end of the housing casing. A reinforcing element composed of a second material is embedded in the bearing plate. In addition, an electric machine having such a housing, a vehicle having such an electric machine and a method for producing the housing are described.

The invention relates to a house for an electric machine, having a hollow-cylindrical housing casing and a circular bearing plate composed of a first material which is arranged at one axial end of the housing casing.

The bearing plate can be produced, for example, as a circular or annular casting which at least partially closes off the housing casing in an axial direction and thus forms an end face of the housing.

The bearing plate can optionally bear a bearing bush for a roller bearing which receives the rotor shaft of a rotor arranged in the housing. In particular, the rotor shaft can project through a central hole of the bearing plate in which the bearing bush is arranged. In addition to the rotor, a stator can be received in the housing, wherein the rotor is rotatable with respect to the stator.

A further bearing plate can additionally be provided which closes off the housing casing in the opposite axial direction and can bear a further bearing of the rotor.

Electric machines of this type are increasingly used in electrically driven vehicles and hybrid vehicles, predominantly as electric motors for driving a wheel or an axle of such a vehicle. The electric motor may be configured, inter alia, as a synchronous motor or an asynchronous motor.

The electric motor is normally mechanically coupled to a gearbox for rotational speed adaptation. The electric motor is additionally generally electrically coupled to an inverter which, from DC voltage that is provided from a battery, generates AC voltage, for example multi-phase AC voltage, for the operation of the electric motor.

It is also possible for the electric machine to be operated as a generator for the recuperation of kinetic energy of a vehicle, wherein the kinetic energy is converted firstly into electrical energy and then into chemical energy of the battery.

On the grounds of saving material and in order to minimize the installation space, the aim is to produce the above-mentioned housing, in particular the bearing plate, with walls which are as thin as possible. However, if the wall thickness of the housing is reduced, the tendency of the electric machine to vibrate in a rotational speed-dependent manner increases.

In order to avoid the occurrence of vibrations, it has already been proposed to provide reinforcing ribs on the bearing plate. However, such reinforcing ribs require additional installation space which is not available in the case of every application of the electric machine. Moreover, the production of the housing with the reinforcing ribs becomes more complicated and thus more expensive.

The object on which the invention is based is therefore to indicate a housing for an electric machine, in the case of which undesirable vibrations are avoided without additional installation space being required.

In order to achieve the object, it is provided according to the invention in the case of a housing of the above-mentioned type that a reinforcing element composed of a second material is embedded in the bearing plate.

The invention is based on the knowledge that the various properties of a first material and of a second material can advantageously be combined with one another in order to increase the rigidity of a component. The embedding of the reinforcing element in the bearing plate furthermore enables the connection of the two components during casting of the bearing plate so that complex mounting of both components can be dispensed with.

The first material can possess a lower density than the second material. The second material can furthermore possess a higher modulus of elasticity than the first material. As a result of this, a particularly high rigidity of the bearing plate is produced, as a result of which the housing is less susceptible to vibrations, in particular in the case of low rotational speeds of a rotor of the electric machine.

As a result of its cylinder configuration, the housing casing defines a (virtual) axial axis along which a first axial direction and an opposite second axial direction run. Starting from the axial axis, several radial directions can furthermore be defined which proceed in each case at a right angle from the axial axis of the housing casing.

The housing casing with the bearing plate is preferably formed in one piece, i.e. as an integral component. As a result of this, a mounting of the two components can be dispensed with. A thickness of the bearing plate preferably lies between 5 and 6 mm, but can also assume a different value, for example, between 3 and 8 mm.

The reinforcing element can furthermore surround a bearing bush which is likewise embedded in the bearing plate. As a result of this, the reinforcing element, bearing bush and bearing plate (or the remains thereof) can be connected to one another in one step, namely during casting of the bearing plate. The bearing bush furthermore contributes to the rigidity of the bearing plate, which further reduces the susceptibility of the electric machine to vibration.

The bearing bush embedded in the bearing plate can serve to bear a rotor of the electric machine. The reinforcing element which surrounds the bearing bush can furthermore be spaced apart from the bearing bush.

The rigidity of the bearing plate can be further increased in that the reinforcing element is formed annularly with radially running struts. The struts run from a central region of the bearing plate outward in each case in a radial direction.

The annular reinforcing element can have in particular an inner ring and an outer ring which surrounds the inner ring, wherein the struts connect the inner ring to the outer ring. The inner ring can, for example, surround the bearing bush integrated in the bearing plate.

It has been shown to be advantageous to arrange the struts asymmetrically and/or along the inner ring or the outer ring at different distances from one another. The asymmetrical arrangement brings about less pronounced excitation of the housing in the case of specific natural frequencies of the rotor.

One further development of the invention provides that the reinforcing element has a first edge region which projects in a first axial direction. The first edge region can be bent or angled in the first axial direction and bring about a further increase in the rigidity of the bearing plate. A sub-region of the first edge region can extend at least approximately perpendicular to a plane defined by the reinforcing element.

The reinforcing element can additionally have a second edge region which projects in a second axial direction opposite to the first axial direction. The second edge region can be bent or angled in the second axial direction and bring about a further increase in the rigidity of the bearing plate. A sub-region of the second edge region can extend at least approximately perpendicular to the plane defined by the reinforcing element. The sub-region of the first edge region and the sub-region of the second edge region can thus run parallel to one another.

It can be provided that the first edge region is located on the outer ring, in particular on the outer edge of the outer ring. Alternatively or additionally, the first edge region can also be located on the inner ring, in particular on the inner edge of the inner ring.

In a similar manner, the second edge region can be located on the outer ring, in particular on the inner edge of the outer ring, on the inner ring, in particular on the outer edge of the inner ring, and/or on an edge of one of the struts.

In the case of one preferred embodiment of the invention, the first edge region is located on the outer ring of the outer ring and on the inner edge of the inner ring, wherein the second edge region is located on the inner edge of the outer ring, on the outer edge of the inner ring and on the edges of the struts.

In the case of the housing according to the invention, the first material can have or be composed of an aluminum alloy. The second material can furthermore have or be composed of a steel alloy. Due to the material mix, the housing can be referred to as a “hybrid aluminum housing”.

In addition, the invention relates to an electric machine having a housing of the described type. A stator, a rotor and possibly further required components can be accommodated in the housing.

The invention also relates to a vehicle which can be driven with such an electric machine. The vehicle can also have several such electric machines, wherein one of the machines is assigned to a wheel or an axle of the vehicle.

In addition, the invention relates to a method of producing a housing of the described type with the following steps: Positioning the reinforcing element produced from the second material in a casting mold, and casting the first material into the casting mold so that the reinforcing element is enclosed by the first material.

In particular, a die-casting process can be used, wherein another type of casting method can also be used, for example, gravity casting.

The reinforcing element used for the method can be produced, inter alia, by punching, laser cutting and/or deep drawing.

The drawings are schematic illustrations in which:

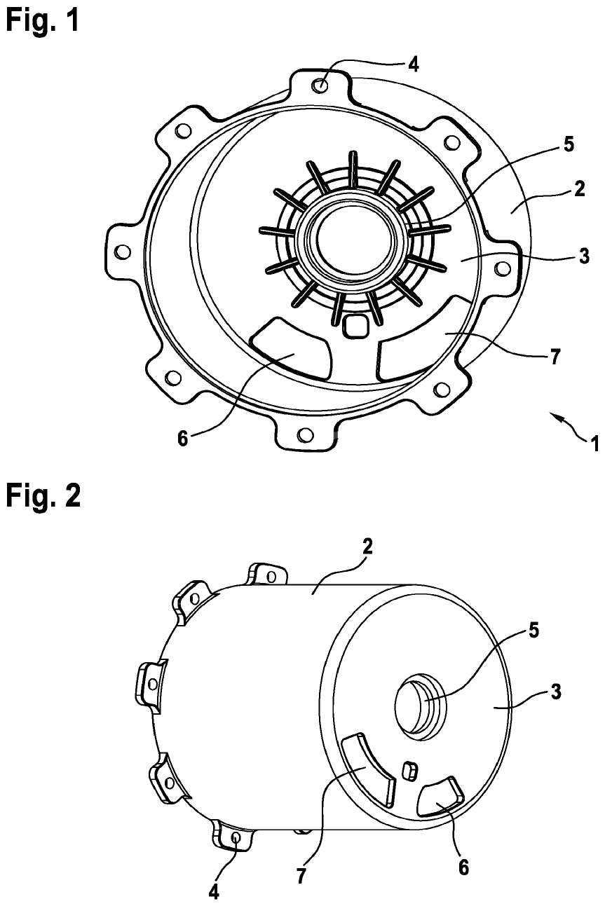

FIG. 1 shows a perspective view of a housing according to one embodiment of the invention with a view of its interior;

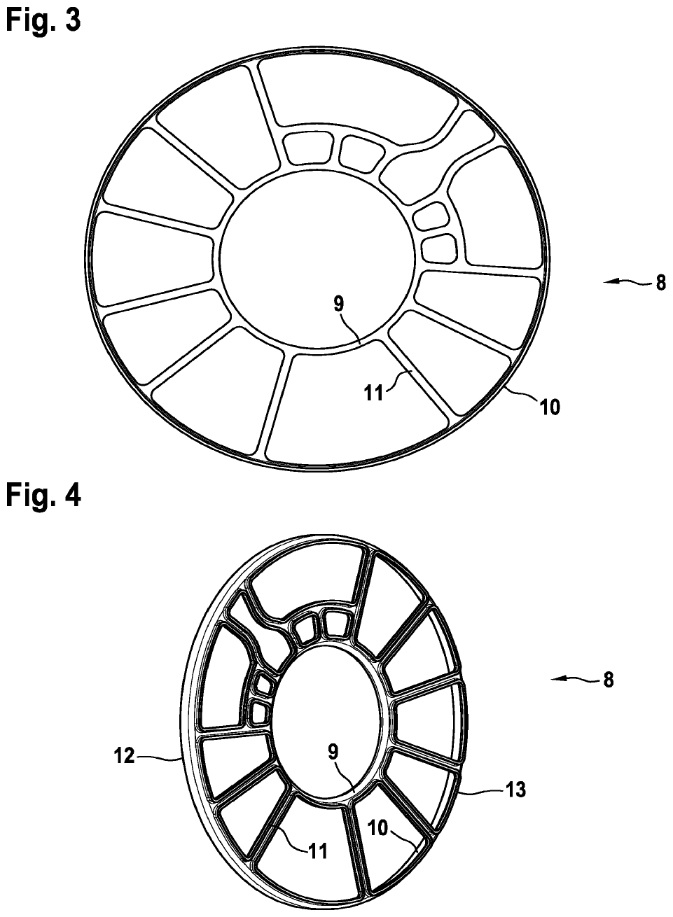

FIG. 2 shows a further perspective view of the housing with a view of its exterior;

FIG. 3 shows an axial view of a reinforcing element of the housing;

FIG. 4 shows a perspective view of the reinforcing element; and

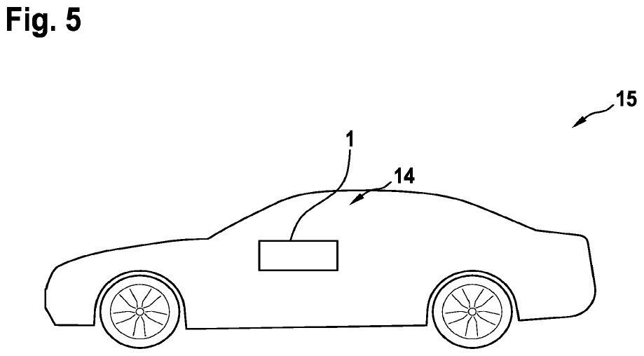

FIG. 5 shows a vehicle according to the invention.

FIG. 1 is a perspective view of a housing 1 according to one embodiment of the invention with a view of its interior. The housing 1 is part of an electric machine with which a vehicle is driven.

The pot-shaped housing 1 has a hollow-cylindrical housing casing 2 and a circular or annular bearing plate 3 which is arranged at a first axial end of the housing casing 2. The housing casing 2 is formed in one piece with the bearing plate 3 so that both components form an integral component.

The housing casing 2 and the majority of the bearing plate 3 are composed of a first material which is an aluminum alloy. A different material can, however, also be used instead of the aluminum alloy.

The bearing plate 3 comprises, among other things, a bearing bush 5 which is arranged in a central hole of the bearing plate 3. The bearing bush 5 is intended to receive a roller bearing for the first end of a rotor shaft (not shown). The rotor shaft belongs to a rotor of the electric machine which should be mounted in the housing 1. The rotor shaft can lead through the bearing bush 5 so that it projects out of the housing 1 and a transmission can be fastened thereto.

The bearing bush 5 is composed of a second material which is a steel alloy. It is surrounded by several reinforcing ribs which extend on the inner side of the bearing plate 3 radially away from the bearing bush 5. Several peripheral holes 6, 7 are furthermore provided in the bearing plate 3, through which holes the cables can be introduced into the housing 1. Such holes can, however, optionally be dispensed with.

The housing 1 serves, in addition to receiving the rotor, to receive a stator (not shown), in which the rotor is rotatable. After arranging the rotor and stator in the housing, the housing 1 can be closed off at its open axial end with a further bearing plate (not shown) which is referred to as a “cover”. The cover can have a further bearing bush which is intended to receive a further roller bearing for the second end of the rotor shaft.

Several eyelets 4 which protrude outward and are distributed over the circumference for fastening the cover are located at the open end of the housing 1.

FIG. 2 is a further view of the housing 1 with a view of its exterior. The outer side of the bearing plate 3 shown in FIG. 2 is formed to be planar or flat, which restricts the installation space required by the housing 1.

FIGS. 3 and 4 show a reinforcing element 8 which has an annular basic shape. FIG. 3 is an axial view and FIG. 4 is a perspective view of the reinforcing element 8.

The reinforcing element 8 is formed to be annular with radially running struts 11. It comprises in particular an inner ring 9 and an outer ring 10 which surrounds the inner ring 9 which are connected to one another with the struts 11.

The reinforcing element 8 is embedded in the bearing plate 3 in such a manner that the inner ring 9 surrounds the bearing bush 5, wherein the inner ring 9 is spaced apart from the bearing bush 5. The reinforcing element 8 is furthermore embedded in the bearing plate 3 in such a manner that the reinforcing element 8 is almost completely covered by the first material. As a result of this, the reinforcing element 8 is substantially not visible for the outside.

The struts 11 are arranged in an at least partially irregular or asymmetrical manner. As a result of this, the spaces between adjacent struts 11 differ in terms of their width.

It is apparent in the perspective view from FIG. 4 that the outer ring 10 on its outer edge and the inner ring 9 on its inner wall have in each case a first edge region 12 which extends in a first axial direction, in the representation from FIG. 4 to the left. The first edge region 12 is at a right angle in relation to the (virtual) plane defined by the reinforcing element 8.

In addition, the outer ring 10 on its inner edge, the inner ring 9 on its outer wall and the struts 11 on their edges have in each case a second edge region 13 which extends in a second axial direction opposite to the first axial direction, in the representation from FIG. 4 to the right. The second edge region 13 is likewise at a right angle relative to the (virtual) plane defined by the reinforcing element 8.

The two edge regions 12, 13 correspondingly point in opposite directions. In particular, a recess, delimited by two adjacent struts 11, the inner ring 9 and the outer ring 10, of the reinforcing element 8 is completely surrounded by the second edge region 13.

The reinforcing element 8 is, like the bearing bush 5, composed of the second material which is a steel alloy. The reinforcing element 8 can, however, also be composed of a different material.

The housing 1 is produced as follows:

In the case of a first method step, the reinforcing element 8 which was previously produced separately is positioned in a casting mold. For this purpose, the reinforcing element 8 can be arranged on the base of the casting mould at a defined distance from the base. The distance corresponds to the thickness of a layer of the first material which should cover the reinforcing element 8 on its outer side.

In order to produce the distance, the reinforcing element 8 can be provided on its under side with several pins (not shown in FIG. 3, FIG. 4) which support the reinforcing element 8 on the base.

In the case of a second method step, the first material is cast in the molten state into the casting mold so that the reinforcing element 8 is enclosed by the liquid first material. A die-casting method can be used for this purpose, or another casting method, for example, a gravity casting method.

After cooling, the housing 1 can be removed from the casting mold.

The reinforcing element 8 was produced from a metal sheet by punching and/or laser cutting. The punched part was furthermore deep-drawn, as a result of which its three-dimensional form is produced.

As a result of the form and the material of the embedded reinforcing element 8, the bearing plate 3 has a high level of rigidity despite small dimensions. The housing 1 of the electric machine is correspondingly characterized by a particularly small inclination toward undesirable oscillations or vibrations.

FIG. 5 shows a vehicle 15, the drive train of which comprises the electric machine 14 which is equipped with the housing 1 and which serves to drive an axle of the vehicle 15.

### LIST OF REFERENCE SIGNS

1 Housing
2 Housing casing
3 Bearing plate
4 Eyelet
5 Bearing bush
6 Opening
7 Opening
8 Reinforcing element
9 Inner ring
10 Outer ring
11 Strut
12 First edge region
13 Second edge region
14 Electric machine
15 Vehicle

1. A housing for an electric machine, having
a hollow-cylindrical housing casing and
a circular bearing plate composed of a first material which is arranged at one axial end of the housing casing,
wherein a reinforcing element composed of a second material is embedded in the bearing plate.

2. The housing as claimed in claim 1, wherein the housing casing is formed in one piece with the bearing plate.

3. The housing as claimed in claim 1, wherein the reinforcing element surrounds a bearing bush embedded in the bearing plate.

4. The housing as claimed in claim 1, wherein the reinforcing element is formed in an annular manner with radially running struts.

5. The housing as claimed in claim 4, wherein the reinforcing element has an inner ring and an outer ring surrounding the inner ring, wherein the struts connect the inner ring to the outer ring.

6. The housing as claimed in claim 5, wherein the struts are arranged asymmetrically and/or along the inner ring at different distances from one another.

7. The housing as claimed in claim 1, wherein the reinforcing element has a first edge region which projects in a first axial direction.

8. The housing as claimed in claim 7, wherein the reinforcing element has a second edge region which projects in a second axial direction opposite to the first axial direction.

9. The housing as claimed in claim 5, wherein the first edge region is arranged on the outer edge of the outer ring and/or on the inner edge of the inner ring.

10. The housing as claimed in claim 8, wherein the second edge region is arranged on the inner edge of the outer ring, on the outer edge of the inner ring and/or on an edge of one of the struts.

11. The housing as claimed in claim 1, wherein the first material has an aluminum alloy and/or the second material has a steel alloy.

12. An electric machine having a housing as claimed in claim 1.

13. A vehicle which is driven with an electric machine as claimed in claim 12.

14. A method of producing a housing as claimed in claim 1, having the steps:
Positioning the reinforcing element in a casting mold,
Casting the first material into the casting mold so that the reinforcing element is enclosed by the first material.

15. The method as claimed in claim 11, wherein the reinforcing element is produced by means of punching, laser cutting and/or deep-drawing of a metal sheet.

16. The housing as claimed in claim 2, wherein the reinforcing element surrounds a bearing bush embedded in the bearing plate.

17. The housing as claimed in claim 2, wherein the reinforcing element is formed in an annular manner with radially running struts.

18. The housing as claimed in claim 2, wherein the reinforcing element has a first edge region which projects in a first axial direction.

19. The housing as claimed in claim 7, wherein the first edge region is arranged on the outer edge of the outer ring and/or on the inner edge of the inner ring.

20. The housing as claimed in claim 9, wherein the second edge region is arranged on the inner edge of the outer ring, on the outer edge of the inner ring and/or on an edge of one of the struts.
